(19) United States
(12) Patent Application Publication
(10) Pub. No.: US 2024/0054722 A1
(43) Pub. Date: Feb. 15, 2024

(54) METHOD AND SYSTEM FOR GENERATING THREE-DIMENSIONAL (3D) MODEL(S) FROM A TWO-DIMENSIONAL (2D) IMAGE OF AN OBJECT

(71) Applicant: MY3DMeta Private Limited, Guwahati (IN)

(72) Inventors: ABHINAV MALL, GORAKHPUR (IN); NEERAJ AGRAWAL, HYDERABAD (IN); HARSHA P DEKA, BENGALURU (IN)

(73) Assignee: MY3DMeta Private Limited, GUWAHATI (IN)

(21) Appl. No.: 18/082,075

(22) Filed: Dec. 15, 2022

(30) Foreign Application Priority Data
Aug. 10, 2022 (IN) 202231045662

(51) Int. Cl. G06T 17/00; G06V 10/764; G06V 10/82; G06V 10/774

(52) U.S. Cl. CPC G06T 17/00; G06V 10/764; G06V 10/82; G06V 10/774

(57) ABSTRACT

Provided is a method and system for generating 3D model from a 2D image of an object. The method and system selects a parameterized base 3D model based on a category of the object. The parameterized base 3D model is representative of one or more parameters corresponding to the object, wherein one or more properties of the parameterized base 3D model change based on changing values associated with the one or more parameters. The method and system predicts, using a machine learning (ML) network, values corresponding to the one or more parameters of the object in the 2D image. The method and system generates a 3D model corresponding to the 2D image based on the predicted values corresponding to the one or more parameters fed to the parameterized base 3D model.

### FIELD OF THE INVENTION

Various embodiments of the present invention generally relate to generating three-dimensional (3D) models of 2D images of objects. More particularly, the invention relates to a method and system that utilizes parameterized base 3D models and machine learning (ML) networks for generating a 3D model from a 2D image of an object.

### BACKGROUND OF THE INVENTION

3D modeling is the process of creating digital mathematical representations of 3D objects, known as 3D models. 3D Computer Aided Design (CAD) modeling is a technique for creating 3D models. Many computer applications for 3D CAD modeling provide the tools for designers to make these 3D representations (models) of objects. 3D models are also created computationally, using data from 3D scanners, sensors, and other forms of input data.

Recent advancements in visualizations and graphics have led to the development of various techniques for 3D modeling or 3D reconstruction of objects. 3D models have applications in multiple domains, such as extended reality, animation, gaming, interior designing, architecture, and medicine.

Many conventional solutions for 3D modeling or 3D reconstruction use an RGB-depth camera or a 3D scanning setup to scan an object of interest and to acquire depth information and color/texture information of the object. A scanning setup may not be efficient for 3D reconstruction, especially when many 3D models of various objects are required for specific applications.

In addition, data convergence, among existing solutions, acts as a significant challenge in 3D modeling or 3D reconstruction from actual images of objects that contain different parameters such as, for example, shape, size, poses, lights, locations, etc. The parameters or 3D points predicted directly from an actual image result in a significant increase in data requirements. Accordingly, values of the predicted parameters will shoot to a very unrealistic number resulting in a flawed 3D model due to an unrealistic parameterized model. Though designers define a maximum and a minimum limit to each parameter to control the quality, the output may not be obtained as desired due to accuracy problems of the parameterized model.

Therefore, there is a need for a method and system for identifying accurate parameters of the image of the object, thereby reducing data requirements to generate a 3D model from the image of the object.

Limitations and disadvantages of conventional approaches will become apparent to one of skill in the art through comparison of described systems with some aspects of the present invention, as outlined in the remainder of the present application and with reference to the drawings.

### SUMMARY OF THE INVENTION

The invention discusses a method and system for generating 3D models from a 2D image of an object, wherein the object can be an organic object, an inorganic object, a real object, a virtual object, and a hybrid object. The method and system comprises selecting a parameterized base 3D model based on a category of the object. The parameterized base 3D model is representative of one or more parameters corresponding to the object, wherein one or more properties of the parameterized base 3D model change based on changing values associated with the one or more parameters. A machine learning (ML) network predicts values corresponding to the one or more parameters of the object in the 2D image. A 3D model corresponding to the 2D image is generated based on the predicted values corresponding to the one or more parameters fed to the parameterized base 3D model.

One or more shortcomings of the prior art are overcome, and additional advantages are provided through the invention. Additional features are realized through the techniques of the invention. Other embodiments and aspects of the disclosure are described in detail herein and are considered a part of the invention.

### BRIEF DESCRIPTION OF THE FIGURES

The accompanying figures, where like reference numerals refer to identical or functionally similar elements throughout the separate views and which, together with the detailed description below, are incorporated in and form part of the specification, serve to further illustrate various embodiments and to explain various principles and advantages all in accordance with the present invention.

FIG. 1 is a diagram that illustrates a computing environment for generating 3D models from a 2D image of an object, in accordance with an embodiment of the invention.

FIG. 2 is a diagram that illustrates a 3D model computing system for generating 3D models from a 2D image of an object in accordance with an embodiment of the invention.

FIG. 3 is a diagram that illustrates a flowchart of a method for generating 3D models from a 2D image of an object in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and components related to a method and system for generating 3D models from a 2D image of an object. Accordingly, the components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any relationship or order between such entities or actions. The terms “comprises,” “comprising,” or any other variation thereof are intended to cover a nonexclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Aspects of the present invention are described herein with reference to flowchart illustrations and/or block diagrams of methods, apparatus (systems), and computer program products according to embodiments of the invention. It will be understood that each block of the flowchart illustrations and/or block diagrams and combinations of blocks in the flowchart illustrations and/or block diagrams can be implemented by computer readable program instructions.

The computer-readable program instructions may also be loaded onto a computer, other programmable data processing apparatus, or other devices to cause a series of operational steps to be performed on the computer, other programmable apparatus, or other devices to produce a computer-implemented process, such that the instructions which execute on the computer, other programmable apparatus, or other device implement the functions/acts specified in the flowchart and/or block diagram block or blocks.

The descriptions of the various embodiments of the present invention have been presented for illustration purposes but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

Generally speaking, pursuant to various embodiments, the invention provides a method and system to generate a 3D model from a 2D image of an object wherein the object can be an organic object, an inorganic image, a real object, a virtual object, and a hybrid object.

The 2D image represents an image that encodes the shape of the object along with the intrinsic and extrinsic properties of the object. The object's intrinsic properties refer to properties that do not change (i.e., remain “invariant”) in the object that undergoes isometric transformations. The “extrinsic properties” of an object refer to properties of the three-dimensional object that change if the object undergoes an isometric transformation.

The method and system converts the 2D image of the object into a standard image (SI) using one or more neural network models and determines a category of the object present in the 2D image. In response to receiving the 2D image, the method and system selects a parameterized base 3D model from a category of objects such as a human, a lamp, a table, a hybrid character in a computer game, etc. The parameterized base 3D model is a model that changes its properties such as shape, size, location, color, texture, etc., based on changes in one or more parameter values. The one or more parameter values can be such as, but not limited to, a numerical value, and an enumeration of values representing a property of the parameterized base 3D model. The property of the parameterized base 3D model can be such as, but are not limited to, a shape, a size, a location, a color, and a texture.

Thereafter, a machine learning (ML) network predicts values corresponding to the one or more parameters of the object in the 2D image. Subsequently, the predicted values corresponding to the one or more parameters are fed to the parameterized base 3D model to generate a 3D model corresponding to the 2D image.

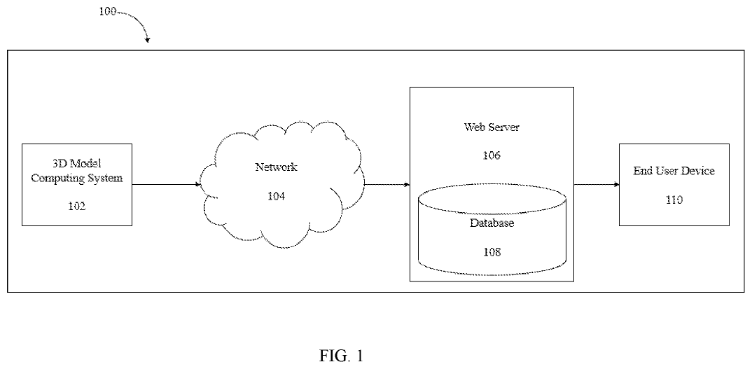

FIG. 1 is a diagram that illustrates a computing environment 100 for generating a 3D model from a 2D image of an object, in accordance with an embodiment of the invention. Referring the FIG. 1, the computing environment 100 comprises a 3D model computing system 102, a network 104, a web server 106 including a database 108, and an end-user device 110.

The 3D model computing system 102 may take the form of a desktop computer, laptop computer, tablet computer, smartphone, smartwatch or other wearable computer, mainframe computer, quantum computer, or any other form of computer or mobile device now known or to be developed in the future that is capable of running a program, accessing a network or querying a database.

As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically the 3D model computing system 102, to keep the presentation as simple as possible. The 3D computing system 102 may be located in a cloud, even though it is not shown in the present disclosure.

In accordance with an embodiment, the network 104 is any network or combination of networks of devices that communicate with one another. For example, the network 104 may be anyone or any combination of a local area network (LAN), wide area network (WAN), home area network (HAN), backbone networks (BBN), peer-to-peer networks (P2P), telephone network, wireless network, point-to-point network, star network, token ring network, single tenant or multi-tenant cloud computing networks, hub network, and public switched telephone network (PSTN), or other appropriate configuration known by a person skilled in the art to interconnect the devices. The end user device 110 may communicate via the network 104 using TCP/IP and use other common Internet protocols to communicate at a higher network level, such as HTTP, FTP, AFS, WAP, etc.

In some embodiments, the network 104 of the computing environment 100 may utilize clustered computing and components acting as a single pool of seamless resources when accessed through the network 104 by one or more computing systems. For example, such embodiments can be used in a data center, cloud computing network, storage area network (SAN), and network-attached storage (NAS) applications.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

A cloud computing environment is service-oriented, focusing on statelessness, low coupling, modularity, and semantic interoperability. At the heart of cloud computing is an infrastructure that includes a network of interconnected nodes.

In some non-limiting embodiments, the cloud computing environment includes a cloud network comprising one or more cloud computing nodes with which cloud consumers may use the end-user device(s) or client devices to access one or more software products, services, applications, and/or workloads provided by cloud service providers or tenants of the cloud network. Examples of the user device are depicted and may include devices such as a desktop computer, laptop computer, smartphone, or cellular telephone, tablet computers, and smart devices such as a smartwatch or smart glasses. Nodes may communicate with one another and may be grouped (not shown) physically or virtually in one or more networks, such as Private, Community, Public, or Hybrid clouds as described hereinabove, or a combination thereof. This allows the cloud computing environment to offer infrastructure, platforms, and/or software as services for which a cloud consumer does not need to maintain resources on a local computing device.

Public Cloud is any computer system available for use by multiple entities that provides on-demand availability of computer system resources and/or other computer capabilities, especially data storage (cloud storage) and computing power, without direct active management by the user.

Private Cloud is similar to the public cloud, except that the computing resources are only available for use by a single enterprise. While the private cloud is depicted as being in communication with WAN, in other embodiments, a private cloud may be disconnected from the internet entirely and only accessible through a local/private network.

A hybrid cloud is composed of multiple clouds of different types (for example, private, community, or public cloud types), often implemented by different vendors. Each of the multiple clouds remains a separate and discrete entity. Still, the larger hybrid cloud architecture is bound together by standardized or proprietary technology that enables orchestration, management, and/or data/application portability between the multiple constituent clouds.

The web server 106 may be a laptop computer, netbook computer, personal computer (PC), a desktop computer, or any programmable electronic device or any network of programmable electronic devices capable of hosting and running a monitoring program and a database and communicating with the end user device 110 via the network 104, in accordance with embodiments of the present invention. As will be discussed with reference to FIG. 1, the web server 106 may include internal components and external components, respectively. The web server 106 may also operate in a cloud computing service model, such as Software as a Service (SaaS), Platform as a Service (PaaS), or Infrastructure as a Service (IaaS). The web server 106 may also be located in a cloud computing deployment model, such as a private cloud, community cloud, public cloud, or hybrid cloud.

The database 108 may be a digital repository capable of data storage and data retrieval. The database 108 can be present in the web server 106 and/or any other location in the network 104. The database 108 may include a knowledge corpus.

The end user device 110 is any computer system used and controlled by an end user (for example, a customer of an enterprise that operates a computer) and may take any of the forms discussed above in connection with the computing environment 100. The end user device 110 typically receives helpful and useful data from the operations in the computing environment 100. For example, in a hypothetical case where the 3D model computing system 102 is designed to provide a recommendation to an end user, this recommendation would typically be communicated via network 104 of the computing environment 100 through a wide area network (WAN). In this way, the end user device 110 can display, or otherwise present, the recommendation to the end user. In some embodiments, the end user device 110 may be a client device, such as a thin client, heavy client, mainframe computer, desktop computer, and so on.

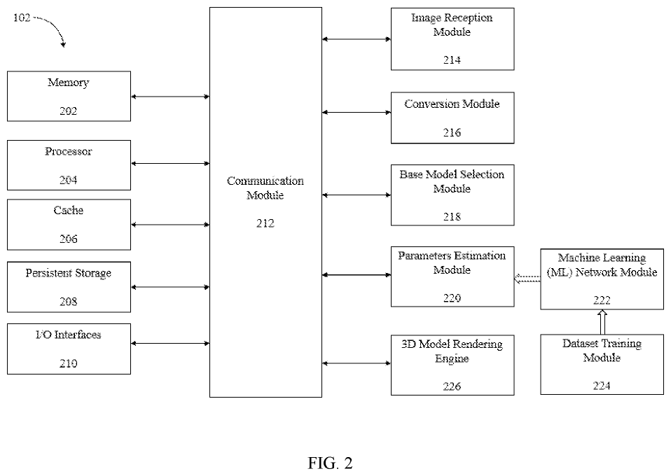

FIG. 2 is a diagram that illustrates the 3D model computing system 102 for generating a 3D model from a 2D image of an object in accordance with an embodiment of the invention. Referring to FIG. 2, the system 200 comprises a memory 202, a processor 204, a cache 206, a persistent storage 208, I/O interfaces 210, a communication module 212, an image reception module 214, a conversion module 216, a base model selection module 218, a parameter estimation module 220, a machine learning (ML) network module 222, a dataset training module 224, and a 3D model rendering engine 226.

The memory 202 may comprise suitable logic and/or interfaces that may be configured to store instructions (for example, the computer-readable program code) that can implement various aspects of the present invention. In an embodiment, the memory 202 includes random access memory (RAM). In general, the memory 202 can include any suitable volatile or non-volatile computer-readable storage media.

The processor 204 may comprise suitable logic, interfaces, and/or code that may be configured to execute the instructions stored in the memory 202 to implement various functionalities of the system 200 in accordance with various aspects of the present invention. The processor 204 may be further configured to communicate with multiple modules of the system 200 via the communication module 212.

The cache 206 is a memory that is typically used for data or code that should be available for rapid access by the threads or cores running on the processor 204. Cache memories are usually organized into multiple levels depending upon relative proximity to the processing circuitry. Alternatively, some, or all, of the cache for the processor set may be located “off-chip”.

Computer readable program instructions are typically loaded onto the system 200 to cause a series of operational steps to be performed by the processor 204 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 206 and the other storage media discussed below. The program instructions, and associated data, are accessed by the processor 204 to control and direct the performance of the inventive methods.

The Persistent storage 208 is any form of non-volatile storage for computers that is now known or to be developed in the future. The non-volatility of this storage means that the stored data is maintained regardless of whether power is being supplied to the system 200 and/or directly to the persistent storage 208. The Persistent storage 208 may be a read only memory (ROM). Still, typically at least a portion of the persistent storage allows writing of data, deletion of data, and re-writing of data. Some familiar forms of persistent storage include magnetic disks and solid-state storage devices. The media used by persistent storage 208 may also be removable. For example, a removable hard drive may be used for persistent storage 208. Other examples include optical and magnetic disks, thumb drives, and smart cards inserted into a drive for transfer onto another computer-readable storage medium that is also part of persistent storage 208.

The I/O interfaces 210 allow for input and output of data with other devices that may be connected to each computer system. For example, the I/O interface(s) 210 may provide a connection to an external device(s) such as a keyboard, a keypad, a touch screen, and/or some other suitable input device. External device(s) can also include portable computer-readable storage media, such as, for example, thumb drives, portable optical or magnetic disks, and memory cards. Program instructions and data (e.g., software and data) used to practice embodiments of the present invention can be stored on such portable computer-readable storage media and loaded onto the persistent storage 208 via the I/O interface(s) 210.

The communication module 212 comprises suitable logic, interfaces, and/or code that may be configured to transmit data between modules, engines, databases, memories, and other components of the image reception module 214, the conversion module 216, the base model selection module 218, the parameter estimation module 220, the machine learning (ML) network module 222, the dataset training module 224, and the 3D model rendering engine 226 for use in performing functions discussed herein. The communication module 212 may include one or more communication types and utilizes various communication methods for communication within the image reception module 214, the conversion module 216, the base model selection module 218, the parameter estimation module 220, the machine learning (ML) network module 222, the dataset training module 224, and the 3D model rendering engine 226.

The image reception module 214 may comprise suitable logic, interfaces, and/or code that may be configured to receive a 2D image of an object such as, but not limited to, an organic object, an inorganic object, a real object, and a virtual object as input. The 2D image received by the image reception module 214 can be a real image (RI) that is in the form of a 2D image obtained by one or more image capturing or scanning devices such as but not limited to, a digital camera, a video recorder, a tablet computer, a notebook computer, a smartphone or the like portable electronic device that comprises an image sensor for capturing the 2D image of the object.

In an exemplary embodiment, a front-facing 2D image is directly uploaded to the 3D model computing system 102. In another embodiment, the 3D model computing system 102 is integrated with platform Application Programming Interfaces (APIs) to upload the 2D images.

The platform APIs provide access to a computing platform definition and entries included therein. The computing platform definition includes entries that indicate the devices and executables to be deployed to a computing platform. The entries may also include build dependency entries that indicate dependencies to build when building the executables of the computing platform.

An interface of the APIs includes callable units linked with portions of the computing platform definition that, when initiated, provide the linked portions of the computing platform definition. For instance, the interface of the APIs may include callable units, that, when respectively invoked, provide, for example, the computing platform definition itself, at least one of the device entries, at least one of the executable entries, at least one of the build dependency entries, and a deployment sequence.

The image reception module 214 may comprise suitable logic, interfaces, and/or code that may be configured to categorize the object in the 2D image, received by the image reception module 214, into one or more categories such as, but not limited to, a human, a lamp, a table, or a hybrid character in a computer game.

In an exemplary embodiment, categories of the object in the 2D image can be identified using one or more object detection algorithms such as, for example, YOLO®, which utilizes neural networks for real-time object detection in digital images or videos.

The conversion module 216 may comprise suitable logic, interfaces, and/or code that may be configured to convert the 2D image of the object to a standardized image (SI) using one or more neural network (NN) models. In an embodiment, the conversion module 216 is configured to normalize one or more properties of the 2D image, such as pose, lighting, background, camera angle, distance, and clothing. For instance, an SI can be an image with properties such as, but not limited to, no clothes, standard pose, standard lighting, and no background.

The NN models that are used to convert the 2D image of an object to a SI can be from a neural network architecture that runs efficiently on mobile computing devices such as smartphones, tablet computing devices, etc.

In an exemplary embodiment, the NN models can be but are not limited to MobileNet V1, MobileNet V2, MobileNet V3, ResNet, NASNet, EfficientNet, and others. These neural networks may replace convolutional layers with depth-wise separable convolutions. For example, the depth-wise separable convolution block includes a depth-wise convolution layer to filter an input, followed by a pointwise (e.g., 1×1) convolution layer that combines the filtered values to obtain new features. The result is similar to that of a conventional convolutional layer but faster.

Generally, NN running on mobile computing devices includes a stack or stacks of residual blocks. Each residual block may include an expansion layer, a filter layer, and a compression layer.

With MobileNet V2, three convolutional layers are included: a 1×1 convolution layer, a 3×3 depth-wise convolution layer, and another 1×1 convolution layer. The first 1×1 convolution layer may be the expansion layer and operates to expand the number of channels in the data prior to the depth-wise convolution and is tuned with an expansion factor that determines the extent of the expansion and, thus, the number of channels to be output. In some examples, the expansion factor may be six. However, the particular value may vary depending on the system. The second 1×1 convolution layer, the compression layer, may reduce the number of channels and, thus, the amount of data through the network. In Mobile Net V2, the compression layer includes another 1×1 kernel. Additionally, with MobileNet V2, there is a residual connection to help gradients flow through the network and connects the input to the block to the output from the block.

The base model selection module 218 may comprise suitable logic, interfaces, and/or code that may be configured to select a parameterized base 3D model for the given category of the SI of the object. A parameterized base 3D model is a model that 3D designers manually craft, that is configured to change its properties such as, but not limited to, shape, size, location, color, and texture based on changes in the value of the parameter. The parameter's value can be such as, but not limited to, a numerical value, and an enumeration of values representing the property of the parameterized base model.

In an embodiment, the number of parameters of the parameterized 3D model can be indicated as ‘n.’ Then ‘n’ parameters of the parameterized base 3D model object are represented as,

P=<p₁,p₂, . . . ,pₙ>
Where pₙ could be a numerical or an enumeration of values representing a property of the parameterized base 3D model

In an exemplary embodiment, a parameterized base 3D model can be such as, but not limited to, a cylindrical lamp base 3D model, a humanoid base 3D model, a table base 3D model, a chair base 3D model, a gun base 3D model, a card base 3D model, a hybrid 3D character in a computer game, and any organic or inorganic object.

In an exemplary embodiment, considering the cylindrical lamp, parameters for a base cylindrical lamp 3D model can be such as, but not limited to, the radius of the spherical lamp (r), the height of the lamp (h), and color of the lamp (c). Here n=3, p₁=r, p₂=h, and p₃=c.

The parameter estimation module 220 may comprise suitable logic, interfaces, and/or code that may be configured to estimate the values of one or more parameters associated with the 2D image of the object. Once a category of the 2D image received as input is determined and a relevant parameterized base 3D model is retrieved, the parameter estimation module 220 is configured to estimate the values of one or more parameters associated with the 2D image of the object.

The machine learning (ML) network module 222 may comprise suitable logic, interfaces, and/or code that may be configured to run one or more machine learning (ML) algorithms. The parameter estimation module 220 and the ML network module 222 are configured to work in conjunction to estimate the values of the one or more parameters associated with the 2D image of the object.

The dataset training module 224 may comprise suitable logic, interfaces, and/or code that may be configured to generate a training dataset for training the ML algorithms of the ML network module 222. The ML network can be a series of ML networks or parallel ML networks.

In accordance with an embodiment, the dataset training module 224 is configured to generate a training dataset using the parameterized base 3D model. The dataset training module 224 is configured to render a plurality of synthetic images corresponding to a category of an object using the parameterized based 3D model. In accordance with an embodiment, the dataset training module 224 is configured to generate random values for one or more parameters with a domain of a parameter type to feed the parameterized 3D model for obtaining the plurality of synthetic images.

Subsequently, a training dataset is generated using the plurality of synthetic images obtained using the random values for the one or more parameters.

Considering an exemplary embodiment wherein a parameterized base 3D model corresponds to a cylindrical lamp. The parameters for the base cylindrical lamp 3D model can include but are not limited to, the spherical lamp's radius, the lamp's height, and the lamp's color. Accordingly, the dataset training module 224 generates random values for parameters within the domain of the parameter type. The dataset training module 224 then feeds the random values for these parameters to the parameterized base 3D model. It renders a base 3D model corresponding to each combination of the parameters' values using a 3D modeling software.

The 3D modeling software creates a mathematical representation of a three-dimensional object or shape. In other ways, 3D modeling is developing a mathematical coordinate-based representation of any surface of an object (inanimate or living) in three dimensions via specialized software by manipulating edges, vertices, and polygons in a simulated 3D space. The 3D modeling software renders the base 3D model by varying the attributes such as, but not limited to, camera position, lighting conditions such as position and intensity, and background.

In accordance with an embodiment, the dataset training module 224 is configured to save a synthetic real image corresponding to each of the rendered 3D models. Each dataset is saved as a tuple containing details about the synthetic image (SI) and the parameters' values. Thereby, the training dataset gets generated by keeping such information about multiple combinations of values of the parameters.

In some non-limiting embodiments, the training dataset may be utilized in a machine learning model or a network, wherein the machine learning network may produce a goal output. In some other embodiments, the training dataset may be utilized to produce multiple goal outputs. Different goal outputs may allow for a range of uses for the same set of the training dataset. For example, an entity may want different goal outputs for different uses. As another example, different entities may want different goal outputs.

Thus, the ML network module 222 is configured to get trained using the dataset generated by the data training module 224.

The one or more machine learning models that can be used in the system 200 described herein may include, but are not limited to, any of the following, Ordinary Least Squares Regression (OLSR), Linear Regression, Logistic Regression, Stepwise Regression, Multivariate Adaptive Regression Splines (MARS), Locally Estimated Scatterplot Smoothing (LOESS), Instance-based Algorithms, k-Nearest Neighbor (KNN), Learning Vector Quantization (LVQ), Self-Organizing Map (SOM), Locally Weighted Learning (LWL), Regularization Algorithms, Ridge Regression, Least Absolute Shrinkage and Selection Operator (LASSO), Elastic Net, Least-Angle Regression (LARS), Decision Tree Algorithms, Classification and Regression Tree (CART), Iterative Dichotomizer 3 (ID3), C4.5 and C5.0 (different versions of a powerful approach), Chi-squared Automatic Interaction Detection (CHAID), Decision Stump, M5, Conditional Decision Trees, Naive Bayes, Gaussian Naive Bayes, Causality Networks (CN), Multinomial Naive Bayes, Averaged One-Dependence Estimators (AODE), Bayesian Belief Network (BBN), Bayesian Network (BN), k-Means, k-Medians, K-cluster, Expectation Maximization (EM), Hierarchical Clustering, Association Rule Learning Algorithms, A-priori algorithm, Eclat algorithm, Artificial Neural Network Algorithms, Perceptron, Back-Propagation, Hopfield Network, Radial Basis Function Network (RBFN), Deep Learning Algorithms, Deep Boltzmann Machine (DBM), Deep Belief Networks (DBN), Convolutional Neural Network (CNN), Deep Metric Learning, Stacked Auto-Encoders, Dimensionality Reduction Algorithms, Principal Component Analysis (PCA), Principal Component Regression (PCR), Partial Least Squares Regression (PLSR), Collaborative Filtering (CF), Latent Affinity Matching (LAM), Cerebri Value Computation (CVC), Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA), Ensemble Algorithms, Boosting, Bootstrapped Aggregation (Bagging), AdaBoost, Stacked Generalization (blending), Gradient Boosting Machines (GBM), Gradient Boosted Regression Trees (GBRT), Random Forest, Computational intelligence (evolutionary algorithms, etc.), Computer Vision (CV), Natural Language Processing (NLP), Recommender Systems, Reinforcement Learning, Graphical Models, or separable convolutions (e.g., depth-separable convolutions, spatial separable convolutions).

The 3D model rendering engine 226 may comprise suitable logic, interfaces, and/or code that may be configured to, upon receiving the estimated parameters from the parameters estimation module 220, generate a 3D model as an output corresponding to the 2D image of the object. In accordance with an embodiment, the 3D model rendering engine 226 feeds the estimated values of the parameters to a parameterized base 3D model for generating a 3D model as the output for the 2D image of the object. The generated 3D model is then exported as required for a final application.

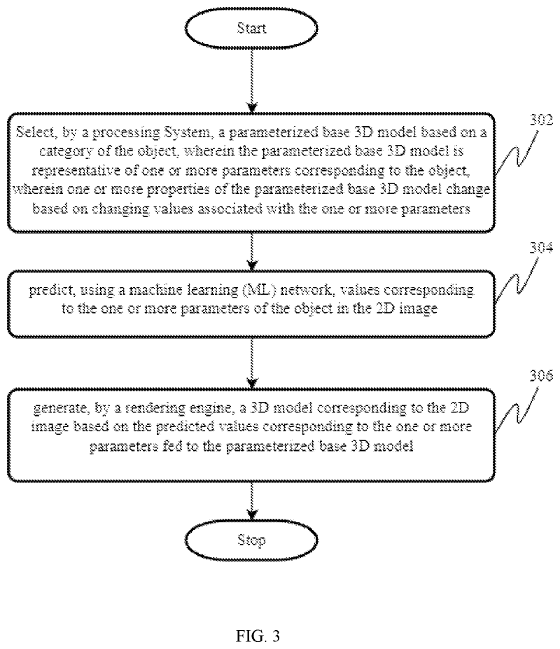

FIG. 3 is a diagram that illustrates a flowchart of a method for generating a 3D model from a 2D image of an object in accordance with an embodiment of the disclosure. Referring to FIG. 3, there is shown a flowchart of a method 300 for generating 3D model from a 2D image of an object.

At step 302, select, by a processing system, a parameterized base 3D model based on a category of the object, wherein the parameterized base 3D model is representative of one or more parameters corresponding to the object, wherein one or more properties of the parameterized 3D model change based on changing values associated with the one or more parameters.

In accordance with an embodiment, the processing system is configured to convert the 2D image into a standard image (SI) using one or more neural network (NN) models. The processing system is configured to normalize one or more properties such as a pose, lighting, background, camera angle, distance, and clothing of the 2D image for converting the 2D image into a SI image.

The processing system is further configured to determine a category of the object in the 2D image. The object category can be but is not limited to, inorganic, organic, real, a hybrid character, a table, a lamp, and a human.

In response to determining the category of the object, the processing system is configured to retrieve a parameterized base 3D model corresponding to the category.

In an exemplary embodiment, the parameterized base 3D model can be such as, but not limited to, a cylindrical lamp base 3D model, a humanoid base 3D model, a table base 3D model, a chair base 3D model, a gun base 3D model, a card base 3D model, a hybrid 3D character in a computer game, and any organic or inorganic object.

Subsequently, the processing system identifies one or more parameters associated with the parameterized base 3D model.

At step 304, predict using a machine learning (ML) network, values corresponding to the one or more parameters of the object in the 2D image. The ML network includes a series of ML networks or parallel ML networks. The ML network is configured to predict values of the one or more parameters of the object in the 2D image.

In accordance with an embodiment, the ML network is trained using a training dataset that is generated using the parameterized base 3D model. A plurality of synthetic images corresponding to a category of an object is generated using the parameterized base 3D model. Random values for one or more parameters with a domain of a parameter type are generated to feed the parameterized base 3D model for obtaining the plurality of synthetic real images.

Subsequently, the training dataset is generated using the plurality of synthetic images obtained using the random values for the one or more parameters. Each dataset is saved as a tuple with details about synthetic real image (SRI) and parameters' values. Thereby, the training dataset gets generated by keeping such information about multiple combinations of values of the parameters.

In some non-limiting embodiments, the training dataset may be utilized in a machine learning model or a network, wherein the machine learning network may produce a goal output. In some other embodiments, the training dataset may be utilized to produce multiple goal outputs. Different goal outputs may allow for a range of uses for the same set of the training dataset. For example, an entity may want different goal outputs for different uses. As another example, different entities may want different goal outputs.

At step 306, generate by a rendering engine a 3D model corresponding to the 2D image based on the predicted values corresponding to the one or more parameters fed to the parameterized base 3D model. In accordance with an embodiment, the rendering engine is configured to feed the estimated values of the parameters to a parameterized base 3D model for generating a 3D model as the output for the 2D image of the object. The generated 3D model is then exported as required for a final application.

The present invention is advantageous in that it uses an ML network for customizing a relevant/appropriate parameterized base 3D model for generating a 3D model corresponding to a 2D image of an object. By estimating the parameters of an object in a 2D image, the invention can develop any possible 3D models. By utilizing the ML models, the system can automate the process of estimating the parameters and create multiple similar-looking 3D models from a 2D image, wherein the numerous 3D models can be used in various domains and applications.

Another advantage of the invention is that it generates the training dataset for the ML networks using the set of parameterized base 3D models. By generating random values corresponding to the one or more parameters of a parameterized base 3D model, the invention can generate numerous training dataset for a given category of an object. Therefore, the ML network can be trained against an extensive dataset efficiently and effectively.

Those skilled in the art will realize that the above-recognized advantages and other advantages described herein are merely exemplary and are not meant to be a complete rendering of all of the advantages of the various embodiments of the present invention.

In the foregoing complete specification, specific embodiments of the present invention have been described. However, one of ordinary skills in the art appreciates that various modifications and changes can be made without departing from the scope of the present invention. Accordingly, the specification and figures are to be regarded in an illustrative rather than a restrictive sense, and all such modifications are intended to be included within the scope of the present invention.

1. A computer-implemented method for generating a three-dimensional (3D) model from a two-dimensional (2D) image of an object, the method comprising:
selecting, by a processing system, a parameterized base 3D model based on a category of the object, wherein the parameterized base 3D model is representative of one or more parameters corresponding to the object, wherein one or more properties of the parameterized base 3D model change based on changing values associated with the one or more parameters;
predicting, using a machine learning (ML) network, values corresponding to the one or more parameters of the object in the 2D image; and
generating, by a rendering engine, a 3D model corresponding to the 2D image based on the predicted values corresponding to the one or more parameters fed to the parameterized base 3D model.

2. The computer-implemented method as claimed in claim 1 comprising receiving, by the processing system, a 2D image, wherein the receiving comprises at least one of uploading a front-facing 2D image and integrating platform Application Programming Interfaces (APIs) to upload the 2D image, wherein the 2D image comprises at least one of a mugshot, whole body pictures, and a sketch.

3. The computer-implemented method as claimed in claim 1, wherein the 2D image is representative of an image that encodes at least one of an intrinsic property and an extrinsic property of the object.

4. The computer-implemented method as claimed in claim 1, wherein a category of an object is at least one of an inorganic object, an organic object, a real object, and a virtual object.

5. The computer-implemented method as claimed in claim 1, wherein a value associated with a parameter comprises at least one of a numerical value and an enumeration of values representing a property of the parameterized base 3D model.

6. The computer-implemented method as claimed in claim 1, wherein the ML network comprises at least one of a series of ML networks and parallel ML networks.

7. The computer-implemented method as claimed in claim 1 comprising identifying, by the processing system, one or more parameters associated with the 2D image of the object, wherein the identifying comprises:
converting the 2D image into a standard image (SI) using one or more neural network models;
determining a category of the object present in the 2D image;
retrieving a parameterized base 3D model corresponding to the category; and
identifying one or more parameters associated with the parameterized base 3D model.

8. The computer-implemented method as claimed in claim 7, wherein the converting comprises normalizing one or more properties of the 2D image, wherein the one or more properties comprise at least one of pose, lighting, background, camera angle, distance and clothing.

9. The computer-implemented method as claimed in claim 1 comprising training, by the processing system, the ML network using a training dataset, wherein the training comprises:
rendering a plurality of synthetic images corresponding to a category of an object using the parameterized base 3D model; and
generating the training dataset using the plurality of synthetic images.

10. The computer-implemented method as claimed in claim 9, wherein the rendering comprises generating random values for one or more parameters within a domain of a parameter type to be fed to the parameterized base 3D model.

11. A system for generating a three-dimensional (3D) model from a two-dimensional (2D) image of an object, the system comprising:
a memory;
a processing system communicatively coupled to the memory, wherein the processing system is configured to select a parameterized base 3D model based on a category of the object, wherein the parameterized base 3D model is representative of one or more parameters corresponding to the object, wherein one or more properties of the parameterized base 3D model change based on changing values associated with the one or more parameters;
a machine learning (ML) network communicatively coupled to the processing system, wherein the ML network is configured to predict values corresponding to the one or more parameters of the object in the 2D image; and
a rendering engine communicatively coupled to the processing system, wherein the rendering engine is configured to generate a 3D model corresponding to the 2D image based on the predicted values corresponding to the one or more parameters fed to the parameterized base 3D model.

12. The system as claimed in claim 11, wherein the processing system is configured to receive a 2D image, wherein the receiving comprises at least one of uploading a front-facing 2D image and integrating platform Application Programming Interfaces (APIs) to upload the 2D image, wherein the 2D image comprises at least one of a mugshot, whole body pictures, and a sketch.

13. The system as claimed in claim 12, wherein the processing system is configured to identify one or more parameters associated with the 2D image of the object, wherein the processing system is further configured to:
convert the 2D image into a standard image (SI) using one or more neural network models;
determine a category of the object present in the 2D image;
retrieve a parameterized base 3D model corresponding to the category; and
identify one or more parameters associated with the parameterized base 3D model.

14. The system as claimed in claim 13, wherein the processing system is configured to normalize one or more properties of the 2D image, wherein the one or more properties comprise at least one of pose, lighting, background, camera angle, distance and clothing.

15. The system as claimed in claim 11, wherein the processing system is configured to train the ML network using a training dataset, wherein the processing system is further configured to:
render a plurality of synthetic images corresponding to a category of an object using the parameterized base 3D model; and
generate the training dataset using the plurality of synthetic images.

16. The system as claimed in claim 15, wherein the processing system is further configured to generate random values for one or more parameters within a domain of a parameter type to be fed to the parameterized base 3D model.
